(19) United States
(12) Patent Application Publication
(10) Pub. No.: US 2025/0244618 A1
(43) Pub. Date: Jul. 31, 2025

(54) MOSCAP SILICON MICRORING MODULATOR DRIVEN BY CONDUCTIVE OXIDE

(71) Applicant: BAYLOR UNIVERSITY, Waco, TX (US)

(72) Inventor: Alan X. Wang, Waco, TX (US)

(73) Assignee: BAYLOR UNIVERSITY, Waco, TX (US)

(21) Appl. No.: 19/034,850

(22) Filed: Jan. 23, 2025

Related U.S. Application Data
(60) Provisional application No. 63/625,742, filed on Jan. 26, 2024.

(51) Int. Cl. G02F 1/025

(52) U.S. Cl. CPC G02F 1/025

(57) ABSTRACT

The disclosure provides a highly efficient MOSCAP modulator that combines silicon photonics with transparent conducting oxide with on-chip wavelength division multiplexing capability. In at least one embodiment, a MOSCAP silicon microring modulator (Si-MRM) is heterogeneously integrated with a nano-sized silicon waveguide, a high dielectric constant insulator deposited on the silicon waveguide, and a high carrier mobility transparent conducting oxide (HMTCO) deposited on the insulator to form an array, gated by the HMTCO. The combination exhibits a high electro-optic modulation efficiency, a low Vπ·L, and consequently can be driven by a sub-volt Vₚₚ at high modulation bandwidth. The utilization of HMTCO reduces the optical waveguide absorption, enabling a balanced Q-factor for sub-volt Vₚₚ modulation while still supporting a large photon lifetime-limited bandwidth. Additionally, the HMTCO, along with optimized doping on the Si microring waveguide and metal electrode patterning, improves the RC bandwidth significantly compared with prior known efforts.

### CROSS REFERENCE TO RELATED APPLICATIONS

This application claims the benefit of U.S. Provisional Application Ser. No. 63/625,742, entitled “MOSCAP Silicon Microring Modulators Driven by Conductive Oxide”, filed Jan. 26, 2024, which is incorporated herein by reference.

### STATEMENT REGARDING FEDERALLY SPONSORED RESEARCH OR DEVELOPMENT

This invention was made with government support under GOALI project 2240352 by the National Science Foundation, NaPSAC N660012424000 by the Defense Advanced Research Projects Agency, ESI program 80NSSC23K0195 by the National Aeronautics and Space Administration, MURI project FA9550-17-1-0071 by the Air Force Office of Scientific Research, and FA9550-20-1-0151 by the Defense University Research Instrumentation Program. The government has certain rights in the invention.

### REFERENCE TO APPENDIX

Not applicable.

### BACKGROUND OF THE INVENTION

### Field of the Invention

The disclosure generally relates to high efficiency silicon semiconductor circuits. More specifically, the disclosure relates to high efficiency silicon semiconductor modulators.

### Description of the Related Art

With the exponentially growing data traffic, the quest for energy-efficient and scalable on-chip optical communication systems has become more imperative. Optical microring resonators have emerged as a key building block of photonic integrated circuits (PICs) that can function as versatile optical devices, including modulators, wavelength filters and multiplexers, in comb lasers, weight banks for neuromorphic computing, and optical sensors. They are playing increasingly critical roles in optical communication, optical interconnects, optical computing, and biomedical sensing due to their ultra-compact footprint and capability for on-chip wavelength-division multiplexing (WDM). Although optical microring resonators have been implemented on various platforms such as thin-film LiNbO₃, silicon nitride, and plasmonics, active silicon microring modulators (Si-MRMs) that can perform high-speed electro-optic (E-O) modulation as the photonic engine for future PICs remains elusive.

Existing Si-MRMs available in the foundry process are based on reversed PN junctions, which can achieve ultra-high modulation bandwidth but usually require more than 2 V of driving voltage (Vₚₚ). The high Vₚₚ makes it unfeasible to drive Si-MRMs directly by CMOS logic circuits. Therefore, high voltage-swing CMOS transmitter (TX) circuits that consume hundreds of milliwatts of power must be used to drive the Si-MRMs, and the energy consumption of the Si-MRM is insignificant compared with that of its CMOS driver. For instance, the 106 Gb/s 2.5 Vₚₚ Si-MRM driver using 28 nm CMOS process consumes 1.33 pJ/bit energy with Pulse-amplitude modulation 4-level (PAM-4) while the Si-MRM itself usually consumes less than 100 fJ/bit energy. Therefore, reducing the driving voltage of the modulator not only lowers the power consumption of the modulator itself, but also enables energy-efficient and high-speed modulator drivers using advanced CMOS nodes that cannot support the high driving voltage of existing silicon photonic modulators.

Thus, there remains a desire to develop high-speed Si-MRMs with sub-volt Vₚₚ and large E-O modulation efficiency.

### BRIEF SUMMARY OF THE INVENTION

The disclosure provides a highly efficient optical interconnect as a metal-oxide-semiconductor capacitor (MOSCAP) microring modulator. The MOSCAP modulator combines silicon photonics with transparent conducting oxide with on-chip wavelength division multiplexing capability. In at least one embodiment, the disclosure provides a highly efficient MOSCAP silicon microring modulator (Si-MRM) heterogeneously integrated with a nano-sized silicon waveguide, a high dielectric constant insulator deposited on the silicon waveguide, and a high carrier mobility transparent conducting oxide (HMTCO) deposited on the insulator to form an array, gated by the TCO. The combination exhibits a high electro-optic modulation efficiency, a low Vπ·L, and consequently can be driven by a sub-volt Vₚₚ at high modulation bandwidth. The HMTCO-gated MOSCAP Si-MRM improves the E-O efficiency by narrowing the microring waveguide width, which effectively improves the overlapping factor between the accumulated carriers and the optical mode profile. The utilization of HMTCO reduces the optical waveguide absorption, enabling a balanced Q-factor for sub-volt Vₚₚ modulation while still supporting a large photon lifetime-limited bandwidth. Additionally, the HMTCO, along with optimized doping on the Si microring waveguide and metal electrode patterning, improves the RC bandwidth significantly compared with prior known efforts.

The disclosure provides a silicon microring modulator (Si-MRM) comprising a nano-sized silicon waveguide, a high dielectric constant insulator having a value of least κ=10 deposited on the silicon waveguide, and a high carrier mobility transparent conducting oxide having a carrier mobility value of at least 60 cm²/(V·s) deposited on the insulator to form an array.

The disclosure further provides The disclosure provides a silicon microring modulator (Si-MRM) comprising: a silicon substrate; a bus waveguide formed on the silicon substrate; a nano-sized silicon microring waveguide coupled to the substrate; a high dielectric constant insulator having a value of least κ=10 deposited on the silicon waveguide; a high carrier mobility transparent conducting oxide (HMTCO) having a carrier mobility value of at least 60 cm²/(V·s) deposited on the insulator to form metal oxide semiconductor capacitor; and a plurality of electrodes and wherein the microring waveguide is formed with a radius and the insulator and HMTCO are formed on the microring waveguide to establish an active region gated by the HMTCO between a first electrode and a second electrode.

The disclosure also provides a method of fabricating a silicon microring modulator on a silicon-on-insulator (SOI) wafer having doped portion configured to form a bus waveguide and a doped portion configured to form a microring with a microring waveguide on a silicon slab, comprising: etching the silicon slab to expose a plurality of doped silicon portions of having different doping levels with a microring waveguide having a height to form at least one sidewall and a top; depositing a layer of dielectric over the plurality of doped silicon portions; depositing a layer of transparent conducting oxide over the silicon slab and the dielectric layer; etching the transparent conducting oxide from a portion of the dielectric layer, leaving the transparent conducting oxide over the dielectric layer on the microring waveguide; etching the dielectric layer over a portion of the plurality of doped silicon portions, leaving the dielectric layer on the microring waveguide and on a portion of the Si slab with the transparent conducting oxide that is distant from the bus waveguide relative to the microring waveguide; and deposition a first electrode on a portion of the silicon slab and portion of the microring and depositing a second electrode on a second portion of the silicon slab distant from the first electrodes relative to the microring waveguide, the first electrode being coupled through the microring to the second conductor.

### BRIEF DESCRIPTION OF THE SEVERAL VIEWS OF THE DRAWINGS

FIG. 1A is a three-dimensional schematic diagram of an illustrative embodiment of the inventive high carrier mobility transparent conducting oxide (HMTCO)-gated MOSCAP silicon microring modulator (Si-MRM) or (HMTCO-gated MOSCAP Si-MRM).

FIG. 1B is a schematic diagram of an enlarged cross-sectional view of an active region of the HMTCO-gated MOSCAP Si-MRM of FIG. 1.

FIG. 2A is a schematic diagram of an illustrative simulation analysis of the HMTCO-gated MOSCAP Si-MRM characteristics showing a simulated carrier distribution in a cross-sectional waveguide of the device at a bias of −2.3 V.

FIG. 2B is a schematic diagram of an enlarged portion of FIG. 2A showing carrier distribution at interfaces between the silicon, high dielectric constant insulator, and HMTCO layers.

FIG. 2C is an illustrative simulated optical mode profile of a transverse-electric (TE) mode in a waveguide of the HMTCO-gated MOSCAP Si-MRM of FIG. 2A.

FIG. 2D is a schematic diagram of an enlarged portion of FIG. 2C showing the simulated optical mode profile at interfaces between the silicon, high dielectric constant insulator, and HMTCO layers.

FIG. 2E is an illustrative graph of a static simulation of a blue-shifted spectra under −1.5 V and −2.3 V of the HMTCO-gated MOSCAP Si-MRM of FIG. 1A.

FIG. 3A is a SEM image of an illustrative fabricated HMTCO-gated MOSCAP Si-MRM showing a passive Si microring resonator with an etched SiO₂ top cladding in the active region after RIE.

FIG. 3B is an enlarged image of a portion of the HMTCO-gated MOSCAP Si-MRM of FIG. 3C showing a top-view SEM image highlighting a narrow Si microring waveguide.

FIG. 3C is an illustrative optical image of the HMTCO-gated MOSCAP Si-MRM with high-speed Ni/Au electrodes.

FIG. 3D is an illustrative optical enlarged SEM image of the HMTCO-gated MOSCAP Si-MRM of FIG. 3C with artificial colors to differentiate portions.

FIG. 4A is a schematic graph of illustrative normalized transmission spectra of the HMTCO-gated MOSCAP Si-MRM with different gate biases.

FIG. 4B is a schematic graph of illustrative measured Q-factor starting on the left Y-axis and Δλres starting on the right Y-axis as a function of the gate bias.

FIG. 4C is a schematic graph of illustrative transmission at λMOD (1317.54 nm) with respect to the gate voltage. It biases at −1.9 V with 0.8 V pp (−1.5 V to −2.3 V) to achieve an ER of 6 dB with an IL of 3 dB.

FIG. 5A is a schematic illustrative graph of measured data and normalized curve for an E-O response (S21) of the HMTCO-gated MOSCAP Si-MRM.

FIG. 5B is a schematic illustrative graph of a normalized E-O response (S21) of the HMTCO-gated MOSCAP Si-MRM.

FIG. 6A are illustrative measured NRZ modulation eye diagrams of the HMTCO-gated MOSCAP Si-MRM with different data rates having a driving voltage of 0.8 Vₚₚ without any pre-emphasis signal.

FIG. 6B are illustrative measured NRZ modulation eye diagrams of the HMTCO-gated MOSCAP Si-MRM with different data rates having a driving voltage of 1.75 Vₚₚ with the pre-emphasis signal.

FIG. 7A is a schematic diagram of a cross-sectional view of an active region of another embodiment of an HMTCO-gated MOSCAP Si-MRM. In this embodiment, the relevant region of the MRM with HMTCO covers only the outer sidewall of the ring.

FIG. 7B is an illustrative graph of a static simulation of a blue-shifted spectra under −1.5 V and −2.0 V of the illustrative HMTCO-gated MOSCAP Si-MRM of FIG. 7A.

FIG. 7C is a schematic graph of an illustrative transmission at λMOD (1317.54 nm) with respect to the gate voltage showing a simulated E-O response (S21) of the HMTCO-gated MOSCAP Si-MRM.

FIG. 8A is a schematic of an illustrative high-speed testing setup for eye diagrams testing.

FIG. 8B is a schematic of an illustrative high-speed testing setup for E-O response testing.

FIG. 9A is a schematic side view of an illustrative Si-MRM array of a plurality of microring waveguides on a common chip with a common bus waveguide.

FIG. 9B is a schematic top view of the Si-MRM array of FIG. 9A.

FIG. 9C is a schematic graph of a measured transmission spectrum with an insert photo showing light confinement within a HMTCO-gated Si-MRM at its resonant wavelength.

FIG. 10A is a partial schematic flow chart of an exemplary process of fabrication of the HMTCO-gated MOSCAP Si-MRM.

FIG. 10B is a further partial schematic flow chart of an exemplary process of fabrication of the HMTCO-gated MOSCAP Si-MRM.

FIG. 10C is a further partial schematic flow chart of an exemplary process of fabrication of the HMTCO-gated MOSCAP Si-MRM.

FIG. 10D is a further schematic flow chart of an exemplary process of fabrication of the HMTCO-gated MOSCAP Si-MRM.

### DETAILED DESCRIPTION

The Figures described above, and the written description of specific structures and functions below, are not presented to limit the scope of what Applicants have invented or the scope of the appended claims. Rather, the Figures and written description are provided to teach any person skilled in the art how to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's goal for the commercial embodiment. Such implementation-specific decisions may include, and likely are not limited to, compliance with system-related, business-related, government-related, and other constraints, which may vary by specific implementation, location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a”, is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The terms “top”, “up', “upward', “bottom”, “down”, “downwardly”, and like directional terms are used to indicate the direction relative to the figures and their illustrated orientation and are not absolute relative to a fixed datum such as the earth in commercial use. The term “inner”, “inward”, “internal” or like terms refers to a direction facing toward a center portion of an assembly or component, such as longitudinal centerline of the assembly or component, and the term “outer”, “outward”, “external” or like terms refers to a direction facing away from the center portion of an assembly or component. The term “coupled”, “coupling”, “coupler”, and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces or members together and may further include without limitation integrally forming one functional member with another in a unitary fashion. The coupling may occur in any direction, including rotationally. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions. Some elements are nominated by a device name for simplicity and would be understood to include a system of related components that are known to those with ordinary skill in the art and may not be specifically described. Some elements are nominated by a device name for simplicity and would be understood to include a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art, given the teachings contained herein. As such, the use of the term “exemplary” is the adjective form of the noun “example” and likewise refers to an illustrative structure, and not necessarily a preferred embodiment. Element numbers with suffix letters, such as “A”, “B”, and so forth, or numbers with prime, double prime, and so forth, such as 1, 1′, 1″, and so forth, are to designate different elements within a group of like elements having a similar structure or function, and corresponding element numbers without the letters are to generally refer to one or more of the like elements. Any element numbers in the claims that correspond to elements disclosed in the application are illustrative and not exclusive, as several embodiments are disclosed that use various element numbers for like elements. Unless otherwise defined, all technical and scientific terms used herein have the same meaning as commonly understood by one of ordinary skill in the art to which this invention belongs. Although various methods, materials, and/or systems similar or equivalent to those described herein can be used in the practice of the present disclosure, suitable methods, materials, and/or materials are described below. In addition, the methods, materials, and/or systems are illustrative and not intended to be limiting, unless stated otherwise. Publications, patents, and other references mentioned herein are incorporated by reference in their entirety, provided that in case of conflict, the present specification, including definitions, will control.

In at least one embodiment, the disclosure provides a MOSCAP-driven Si-MRM array heterogeneously integrated with high carrier mobility titanium-doped indium oxide (ITiO), which can perform on-chip wavelength-division multiplexing (WDM) modulation. The HMTCO-gated MOSCAP Si-MRM performs non-return-to-zero (NRZ) modulation with open eye diagrams up to 30 Gb/s. Additionally, it discloses an enhanced E-O efficiency Vπ·L of 0.12 V·cm, surpassing traditional Si-MRMs using PN junctions where Vπ·L often exceeds 0.5 V·cm. The disclosure provides a moderate gate bias to fine-tune the resonant spectra of Si-MRMs with minimal power consumption. This approach demonstrates the feasibility of tailored modulation performance while maintaining equally spaced working wavelengths for possible integration with comb lasers. The exemplary array can achieve a throughput of (3×25+1×15) Gb/s with a maximum E-O bandwidth of 14 GHz. The exemplary MOSCAP Si-MRM array was fabricated using a high-volume manufacturing process and the TCO layer was patterned with an academic laboratory. This work demonstrates a heterogeneous integration of MOSCAP Si-MRM array for on-chip WDM, marking a significant milestone of the development of MOSCAP modulators towards large-scale precision production.

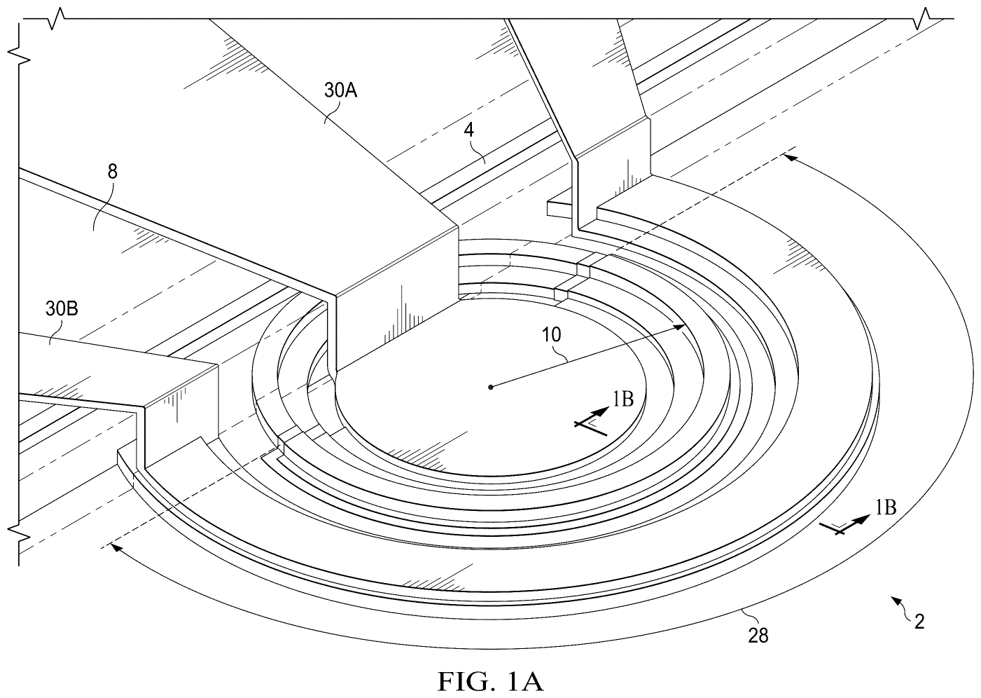

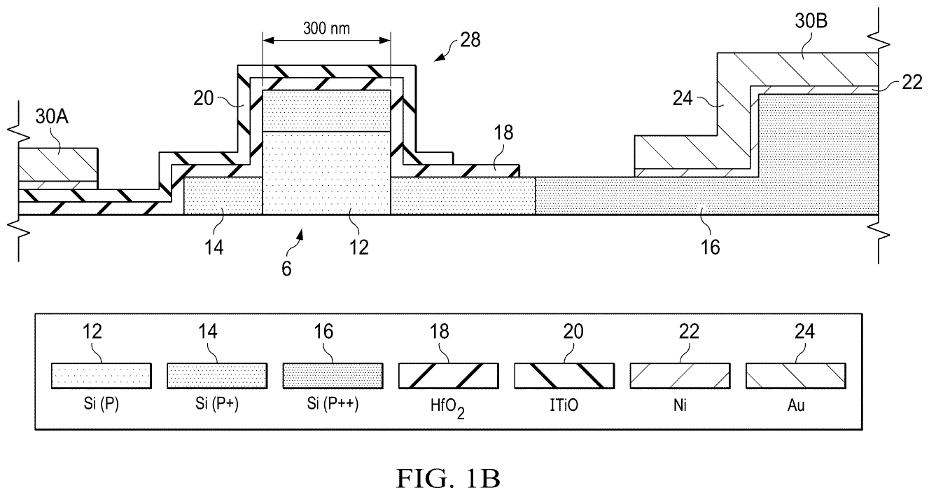

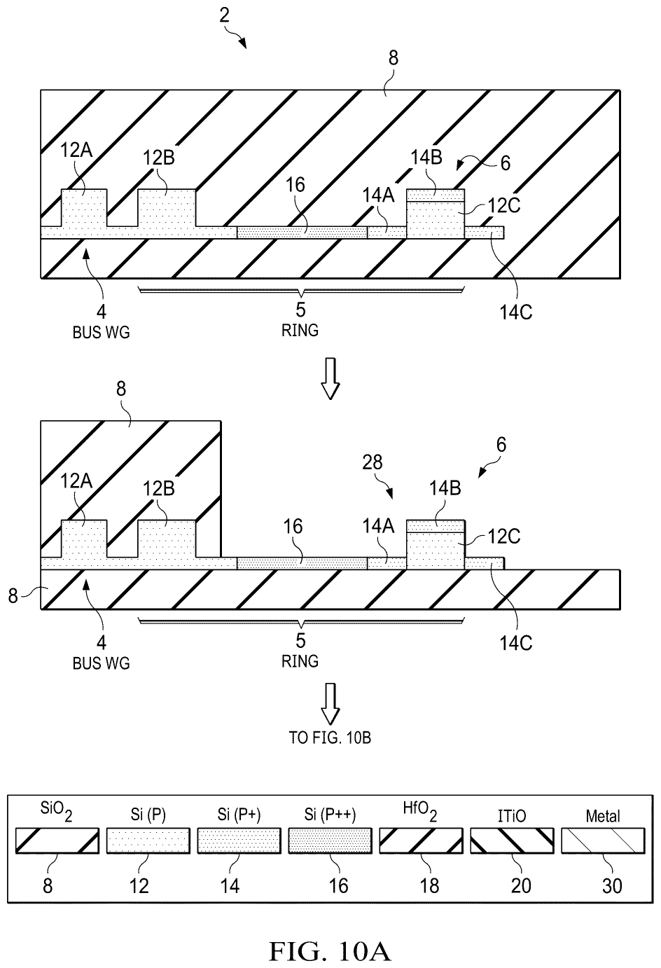

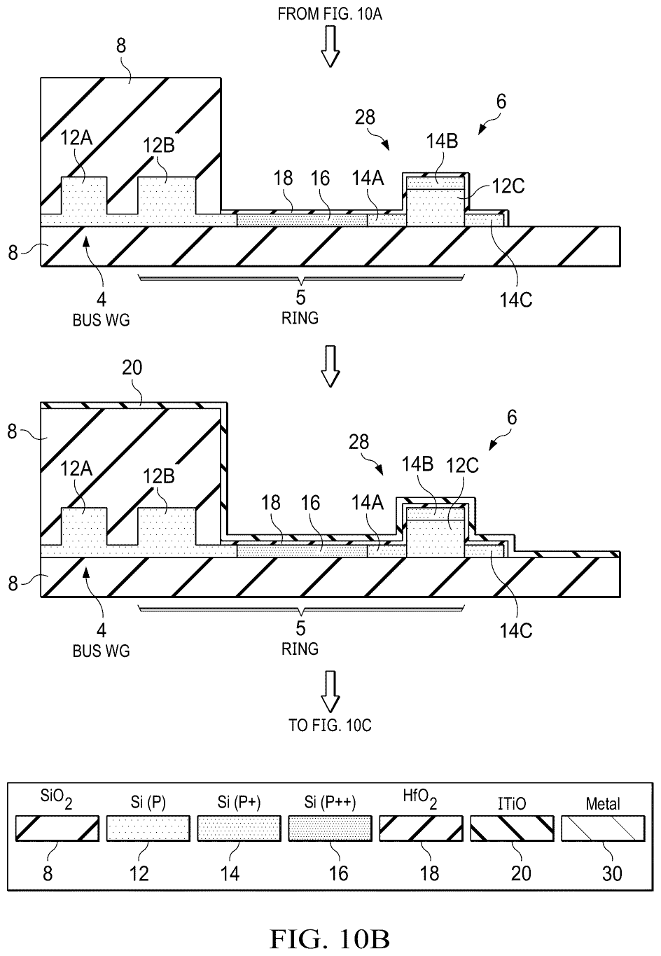

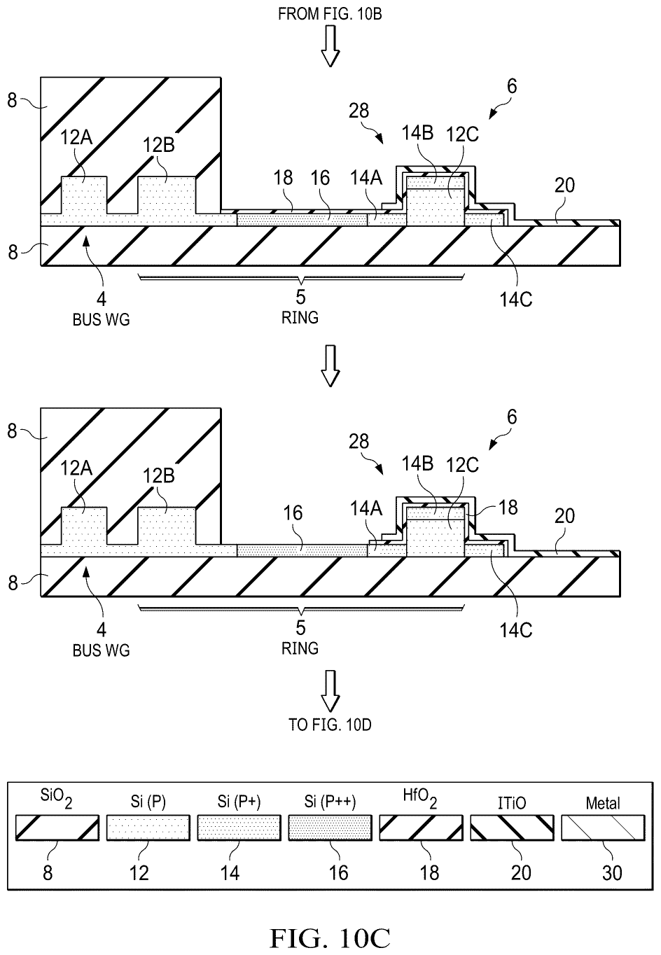

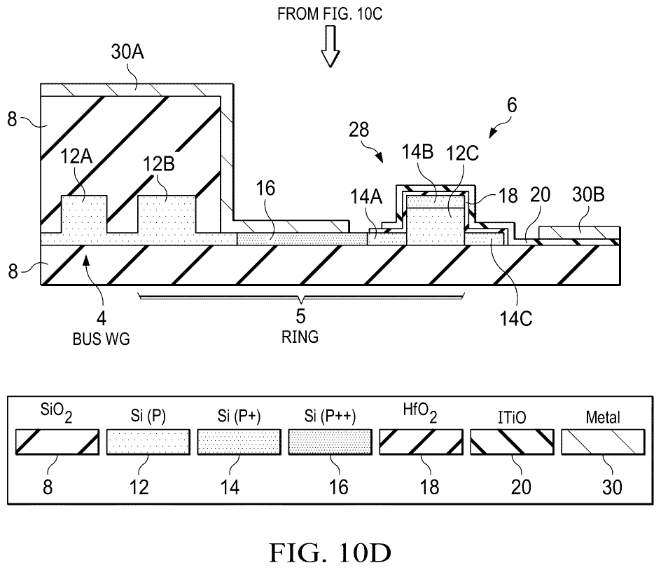

FIG. 1A is a three-dimensional schematic diagram of an illustrative embodiment of the inventive high carrier mobility transparent conducting oxide (HMTCO)-gated MOSCAP silicon microring modulator (Si-MRM) or (HMTCO-gated MOSCAP Si-MRM). FIG. 1B is a schematic diagram of an enlarged cross-sectional view of an active region of the HMTCO-gated MOSCAP Si-MRM of FIG. 1. The figure illustrates a design of a HMTCO-gated MOSCAP Si-MRM 2 using HfO₂ as the dielectric insulator and ITiO as the HMTCO. Variations in composition and dimensions are contemplated. The HMTCO-gated MOSCAP Si-MRM 2 comprises silicon oxide (SiO₂) slab 8 formed with doped portions and deposited layers that are selectively removed in specific locations to form bus waveguide 4 with at least one electrode and a microring waveguide 6 with at least one electrode, as more particularly described in FIG. 10. The device can be formed with a 300 nm thick doped Si rib to form a bus waveguide 4 with a 100 nm SiO₂ slab 8 thickness. A waveguide width of 300 nm is selected to enhance the E-O efficiency, while a radius 10 of 8μm for the waveguide is chosen to reduce the bending loss. The Si doping profile of Si(P) portion 12 (Si positive-type at 1×10¹⁷ cm⁻³), Si(P+) portion 14 (Si positive-type at 3×10¹⁸ cm⁻³), and Si (P++) portion 16 (Si positive-type at 1×10²⁰ cm⁻³) are designed to reduce the series resistance without compromising the optical absorption in the Si waveguide 6. The device 2 has a background Si(P) portion 12, and the Si(P+) portion 14 covers the top of the ring waveguide 6 and part of the SiO₂ slab 8. The Si(P++) portion 16 is placed 600 nm away from the ring waveguide 6 to maintain the Q-factor. Such a doping design allows the passive Si microring resonator to achieve a high Q-factor of 20,000 near the critical coupling condition. The active E-O modulation region 28, which represents approximately 62.5% of the microring circumference (L=31.4 μm), comprises a 10 nm thick HfO₂ insulator layer 18 and a 14 nm ITiO layer 20 on the top. The electrodes 30A and 30B (collectively, 30) of Ni 22 and Au 24 traverse the bus waveguide via the top SiO₂ waveguide cladding, forming ohmic contacts with the ITiO gate and the Si substrate of the MOSCAP.

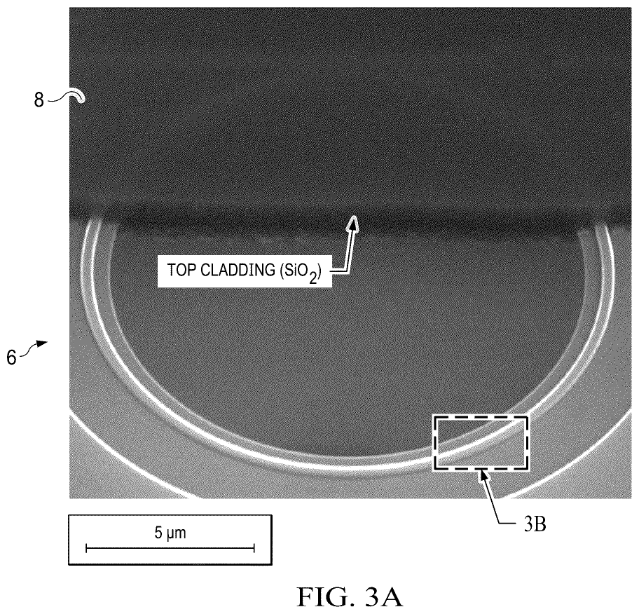

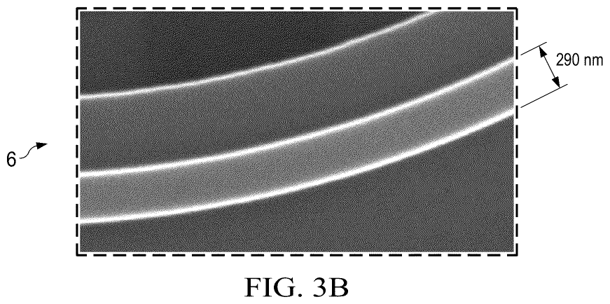

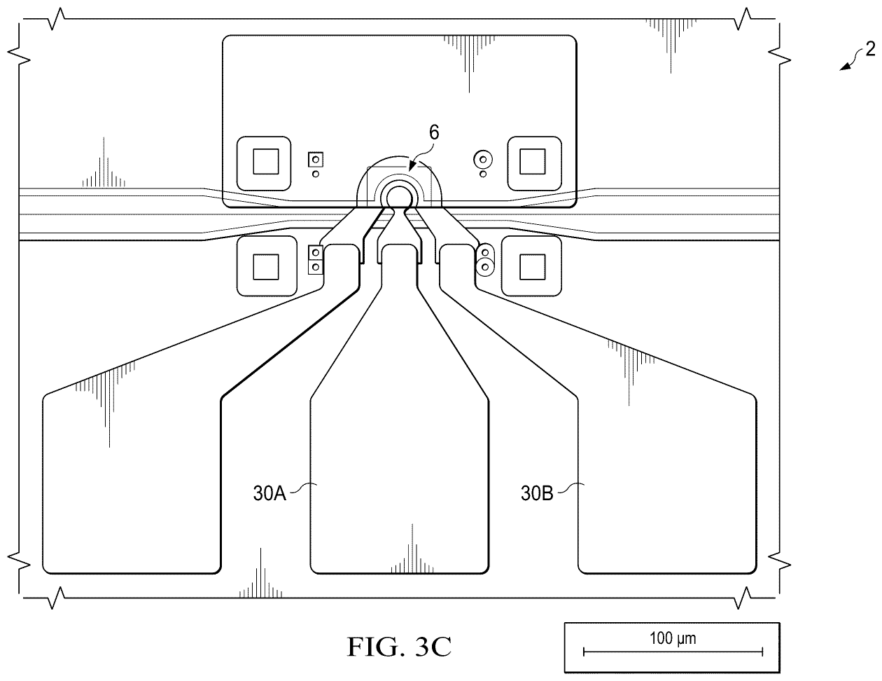

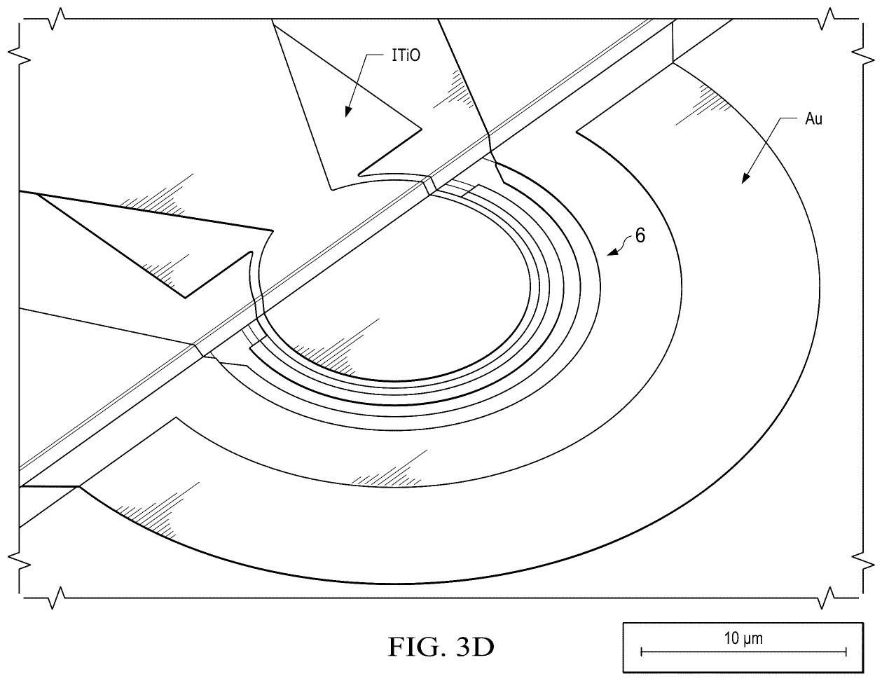

For the illustrated embodiment, the method of fabrication is described below as a nonlimiting example using HfO₂ as the high dielectric constant insulator and ITiO as the high carrier mobility transparent conducting oxide. The passive Si microring resonator was fabricated on a silicon-on-insulator (SOI) wafer. The Si microring waveguide 6 has a narrow waveguide width of 300 nm and a waveguide height of 300 nm while leaving a 100 nm thick Si slab 8 to ensure good optical mode confinement in the Si waveguide 4 and proper electrical conduction. To create the MOSCAP on the microring, the top SiO₂ (“Si”) 8 cladding in the active region of the microring was selectively patterned using regular photolithography, followed by reactive-ion etching (RIE), as shown in FIG. 3A below. Next, a 10 nm HfO₂ insulator layer 18 was deposited on the entire SOI substrate by atomic layer deposition (ALD) using tertrakis (eythylmetylamido)-Hf (TEMA) and H₂O at 300° C. Subsequently, a 14 nm ITiO layer 20 was RF-sputtered onto the HfO₂ layer at a high substrate heating temperature of 500° C., which covered the entire wafer with ITiO. The ITiO layer in the active region 28 was patterned using a two-step process. Electron beam lithography (EBL) with RIE was employed to accurately define the desired ITiO pattern within the active region. Subsequently, regular photolithography with wet etching (ITO etchant) was used to remove any residual ITiO. After these two steps, the ITiO layer only covered approximately 62.5% of the microring circumference. Prior to the metal deposition, the HfO₂ layer in the Si contact region was patterned using EBL and removed by RIE. The Ni/Au electrical contacts 30A and 30B were patterned on the ITiO gate and the Si substrate using EBL, followed by thermal evaporation and lift-off. These contacts were patterned approximately 1.2 μm away from the microring waveguide. Finally, the Ni/Au coplanar ground-signal-ground (GSG) electrode pads were patterned using regular photolithography followed by thermal evaporation and lift-off and were connected to the electrical contacts patterned in the previous step.

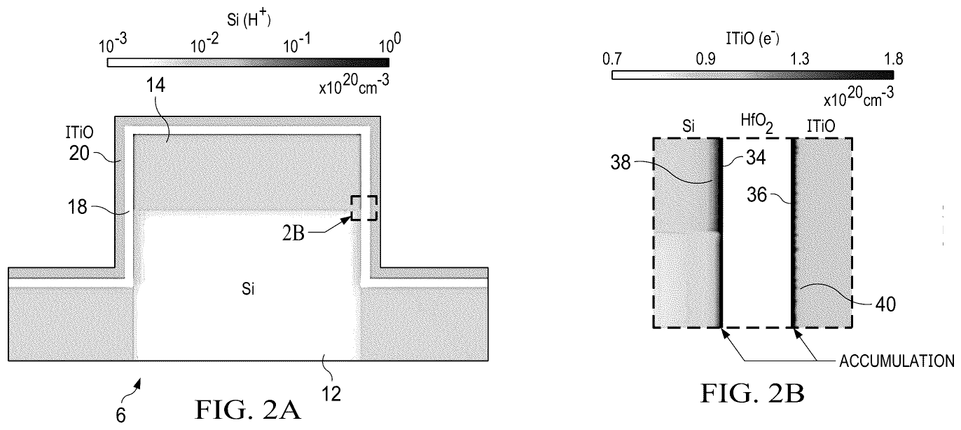

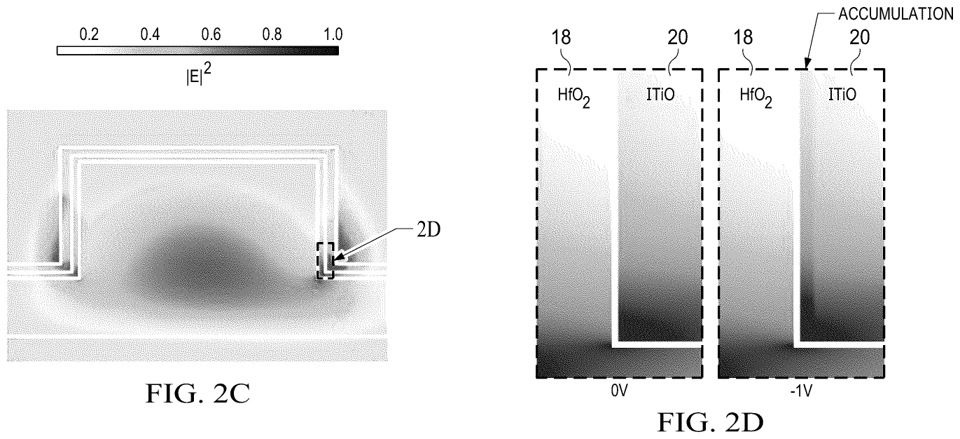

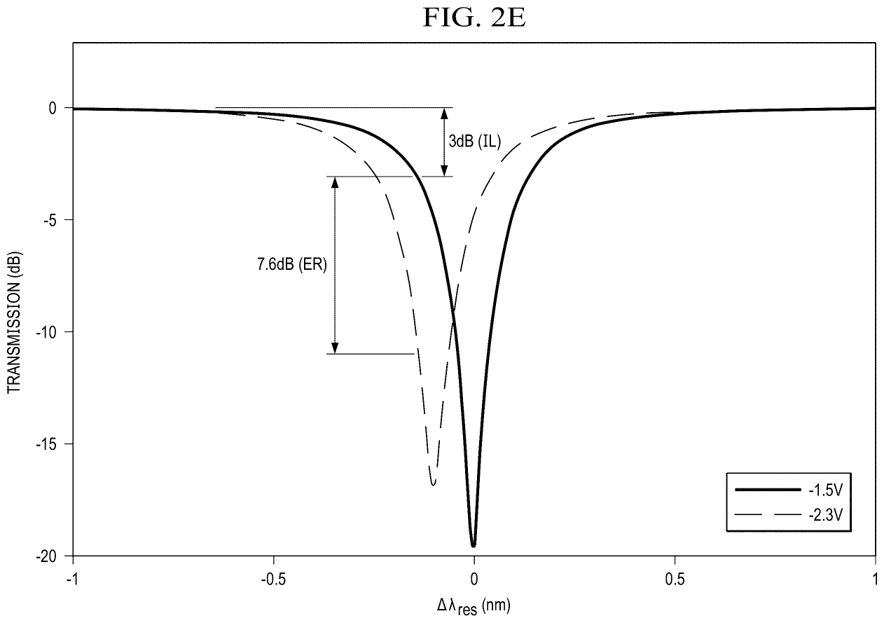

FIG. 2A is a schematic diagram of an illustrative simulation analysis of the HMTCO-gated MOSCAP Si-MRM characteristics showing a simulated carrier distribution in a cross-sectional waveguide of the device at a bias of −2.3 V. FIG. 2B is a schematic diagram of an enlarged portion of FIG. 2A showing carrier distribution at interfaces between the silicon, high dielectric constant insulator, and HMTCO layers. Elements are numbered correspondingly with FIG. 1A and 1B. The color bars represent carrier concentrations for Si and ITiO are indifferent scales. When a negative bias is applied, holes accumulate at the Si/HfO2 and electrons accumulate at the HfO2/ITiO interfaces, respectively. An electron accumulation layer 40 within the ITiO layer is less than 1 nm thick, which is significantly thinner than the hole accumulation layer 38 in the Si microring waveguide due to the different Debye lengths caused by the varying carrier concentration and dielectric constant.

FIG. 2C is an illustrative simulated optical mode profile of a transverse-electric (TE) mode in a waveguide of the HMTCO-gated MOSCAP Si-MRM of FIG. 2A. FIG. 2D is a schematic diagram of an enlarged portion of FIG. 2C showing the simulated optical mode profile at interfaces between the silicon, high dielectric constant insulator, and HMTCO layers. Due to the bending ring waveguide, the optical mode profile shifts toward the outer sidewall of the waveguide. Upon a negative bias, the optical mode interacts with the accumulation charges in both ITiO and doped p-Si, enabling E-O modulation and blue-shifting the resonant wavelength (Δλres). FIG. 2B also provides a zoomed-in view of the optical mode profile at the HfO₂/ITiO interfaces, illustrating examples at 0 V and −1 V biases with a 1 nm thick uniform accumulation layer.

FIG. 2E is an illustrative graph of a static simulation of a blue-shifted spectra under −1.5 V and −2.3 V of the HMTCO-gated MOSCAP Si-MRM of FIG. 1A. The simulation assumes a dielectric constant of 12 for HfO2 and carrier mobility of 62 cm²/(V·s) with a concentration of 1.2×10²⁰ cm⁻³ for ITiO, chosen to align with the experimental material properties. Using such parameters, the ITiO-gated MOSCAP Si-MRM achieves a high Q-factor of 5000 at 0 V with an E-O efficiency of 125 pm/V in the accumulation mode. To balance the output optical power and the driving voltage, we chose a 3 dB insertion loss (IL) point based on the notable reduction in the Lorentzian shape of the microring transmission. In addition, an extinction ratio (ER) at 6 dB is adopted to enable clear eye diagrams, especially when transmitting high-speed data. The combination of 3 dB IL and 6 dB ER is also recommended as a practical and effective choice for E-O modulation in optical transmitters. The simulation results in FIG. 2E also demonstrate that the ITiO-gated MOSCAP Si-MRM can achieve a 7.6 dB ER with 3 dB IL using only 0.8 Vpp, highlighting the potential for efficient modulation.

FIG. 3A is a SEM image of an illustrative fabricated HMTCO-gated MOSCAP Si-MRM showing a passive Si microring resonator with an etched SiO₂ top cladding in the active region after RIE. FIG. 3B is an enlarged image of a portion of the HMTCO-gated MOSCAP Si-MRM of FIG. 3C showing a top-view SEM image highlighting a narrow Si microring waveguide. FIG. 3C is an illustrative optical image of the HMTCO-gated MOSCAP Si-MRM with high-speed Ni/Au electrodes. FIG. 3D is an illustrative optical enlarged SEM image of the HMTCO-gated MOSCAP Si-MRM of FIG. 3C with artificial colors to differentiate portions, which was fabricated by a 300-millimeter silicon-on-insulator (SOI) photonics process. To complete the entire process of the active HMTCO gated MOSCAP Si-MRM 2, the fabrication continued in a cleanroom facility. The SiO₂ top cladding in the active region was then etched by reactive ion etching (RIE). Despite the high etching selectivity between SiO₂ and Si, some Si waveguide was still inadvertently etched during the process. As a result, the width of the Si microring waveguide was slightly narrower than the designed value, measuring 290 nm, as depicted in FIG. 3B. After the entire fabrication process, FIG. 3C shows a top view of the fabricated ITiO-gated MOSCAP Si-MRM 2 with the microring waveguide 6 and electrodes 30A and 30B. Additionally, FIG. 3D provides a zoomed-in SEM image highlighting the ITiO region.

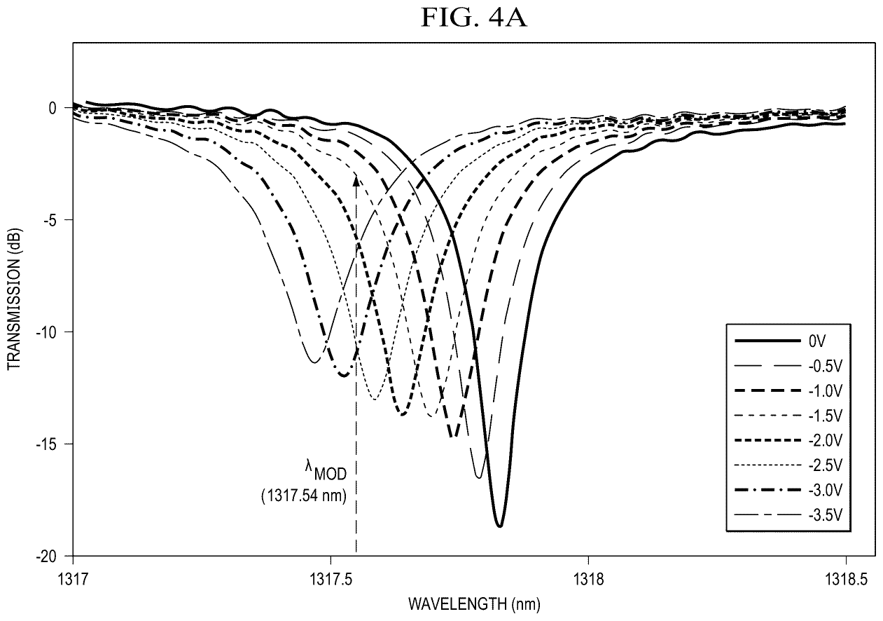

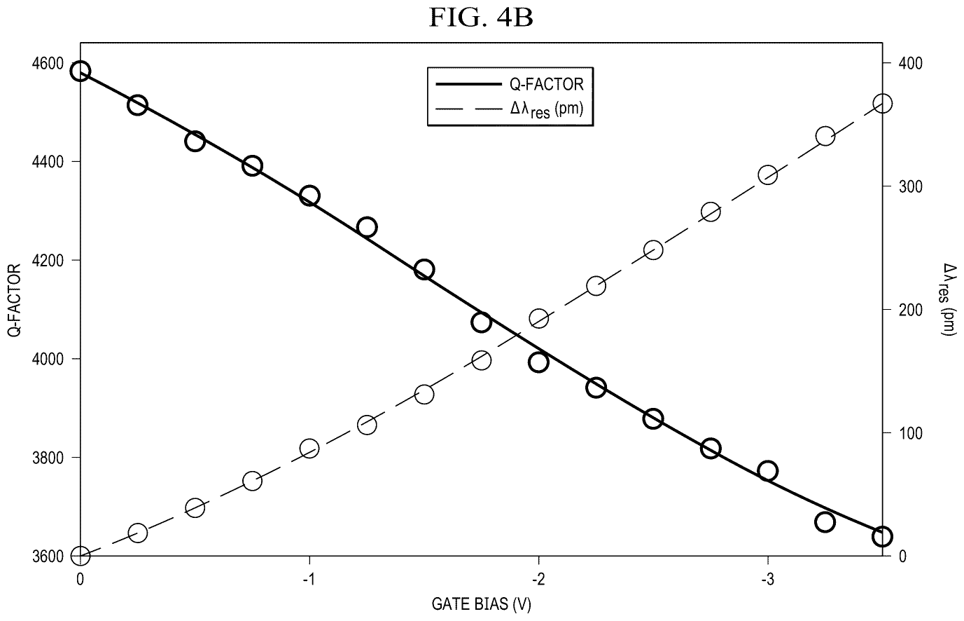

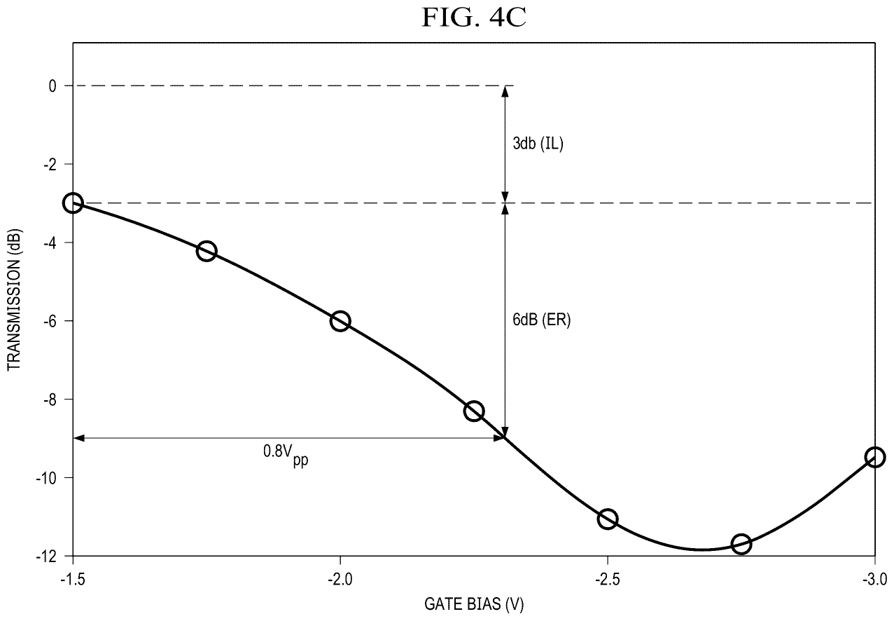

FIG. 4A is a schematic graph of illustrative normalized transmission spectra of the HMTCO-gated MOSCAP Si-MRM with different gate biases. The ITiO-gated MOSCAP Si-MRM was designed to operate at O-band. The device was designed near critical coupling, resulting in a deep resonant dip to enable a modulation condition with an ER exceeding 6 dB and an IL of 3 db. In addition, the critical coupling condition plays an important role in achieving sub-volt modulation. Critical coupling leads to a sharp and deep resonance, which minimizes the required driving voltage. Applying a negative bias to the ITiO gate causes the accumulated carriers in both the Si waveguide and ITiO gate, resulting in Δλres. Simultaneously, such accumulated charges also increase optical absorption and decrease the Q-factor.

FIG. 4B is a schematic graph of illustrative measured Q-factor starting on the left Y-axis and Δλres starting on the right Y-axis as a function of the gate bias. The ITiO-gated MOSCAP Si-MRM exhibits a Q-factor of approximately 4600 at 0 V, supporting an optical bandwidth of 50 GHz. The Q-factor is used to determine the optical loss of the ITiO-gated MOSCAP waveguide at 138 dB/cm. As a comparison, the passive silicon waveguide microring exhibited a loss of 24 dB/cm before the ITiO deposition. Therefore, the introduction of ITiO leads to a significant increase of the optical loss and is a critical factor for device design. For gate biases ranging from 0 V to −1.5 V, the ITiO-gated MOSCAP Si-MRM operates in the depletion mode due to the non-ideal flat-band voltage (VFB), achieving an E-O efficiency of 87 pm/V. Once the negative bias exceeds −1.5 V, the MOSCAP transitions into the accumulation mode, and Δλres becomes more linear, leading to a higher E-O efficiency of 117 pm/V, corresponding to a very low Vπ·L of 0.12 V·cm. Therefore, the ITiO-gated MOSCAP Si-MRM operates in the accumulation mode to achieve a low driving voltage (Vₚₚ). Additionally, it is worth noting that the experimental Q-factor (4600) and E-O efficiency (117 pm/V) obtained were only slightly lower than the simulated values of Q-factor (5000) and E-O efficiency (125 pm/V) with an acceptable error margin of 8%. The modulation wavelength (λMOD) was fine-tuned by a tunable laser to ensure an IL of 3 dB at −1.5 V. The optical transmission for different gate biases at λMOD is shown in FIG. 4C. An ER of 6 dB and an IL of 3 dB can be achieved with a bias voltage of −1.9 V and a voltage swing of 0.8 Vpp (−1.5 V˜−2.3 V). The observed ER, though slightly lower than the expected value, can be attributed to the slightly lower experimental Q-factor and E-O efficiency.

FIG. 4C is a schematic graph of illustrative transmission at λMOD (1317.54 nm) with respect to the gate voltage. It biases at −1.9 V with 0.8 V pp (−1.5 V to −2.3 V) to achieve an ER of 6 dB with an IL of 3 dB. An ER of 6 dB and an IL of 3 dB can be achieved with a bias voltage of −1.9 V and a voltage swing of 0.8 Vpp (−1.5 V˜−2.3 V). The observed ER, though slightly lower than the expected value, can be attributed to the slightly lower experimental Q-factor and E-O efficiency.

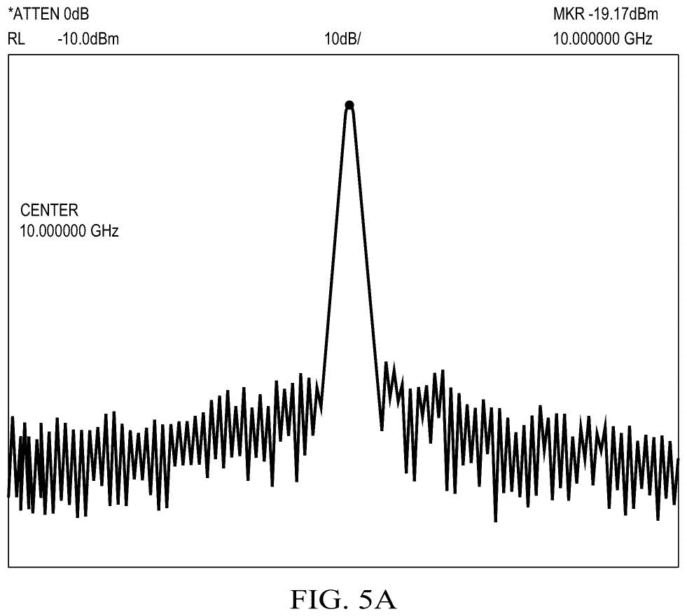

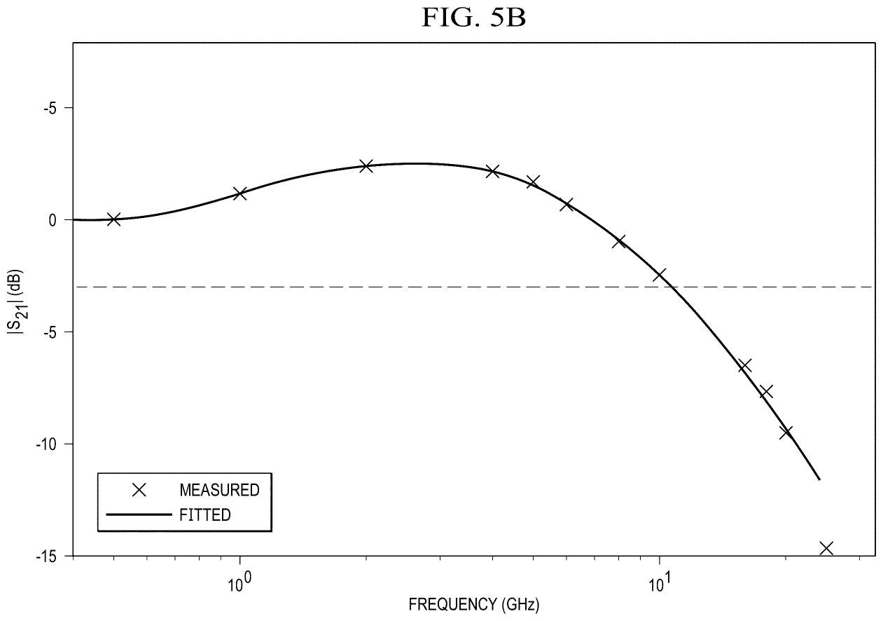

FIG. 5A is a schematic illustrative chart of an electro-optical (E-O) response characterization. Output signal on the MSA at 10 GHz. The E-O response (S21) of the ITiO-gated MOSCAP Si-MRM was measured under the condition of 3 dB IL at −1.5 V. By varying the frequency of the input sine wave driving signal, the corresponding output RF power was measured by a microwave spectrum analyzer (MSA).

FIG. 5B is a schematic illustrative graph of measured data and normalized curve for an E-O response (S21) of the ITiO-gated MOSCAP Si-MRM. The illustrative response is in the frequency range of 500 MHz to 25 GHz. The normalized curve is formed by fitting the discrete data points of the measured RF power to show the device's E-O bandwidth, which considers the effect of detuning, peaking, and RC bandwidth. A tunable laser was fine tuned to the input wavelength to achieve an IL of 3 dB at −1.5 V. The E-O response exhibits the peaking effect, enhancing the 3 dB bandwidth to 11 GHz. It provides the potential for supporting the ITiO-gated MOSCAP Si-MRM in achieving non-return-to-zero (NRZ) modulation at data rates exceeding 20 Gb/s. For the E-O modulation measurement, the ITiO-gated MOSCAP Si-MRM was biased at the IL of 3 dB at −1.5 V and driven by 0.8 Vₚₚ NRZ pseudorandom binary sequence (PRBS) signals. PRBS9 was used for data rates lower than 10 Gb/s, and PRBS15 was employed for higher data rates to ensure sufficient data randomness for characterization. The device's capacitance was measured to estimate the modulation energy consumption using CV²/4. It is worth noting that the measured capacitance included parasitic capacitance arising from the waveguide slab. This parasitic capacitance does not play a role in modulation. To accurately estimate the best possible modulation energy, it is crucial to exclude such effect. Since the capacitance changes with the applied gate bias as indicated in the C-V characteristics, the capacitance (after eliminating the parasitic capacitance) was found to be 333 fF at −1.9 V, which corresponds to the center of the 0.8 V voltage swing (−1.5 V to −2.3 V). Considering the modulation energy consumption (CV²/4), the estimated energy consumption is 53 fJ/bit.

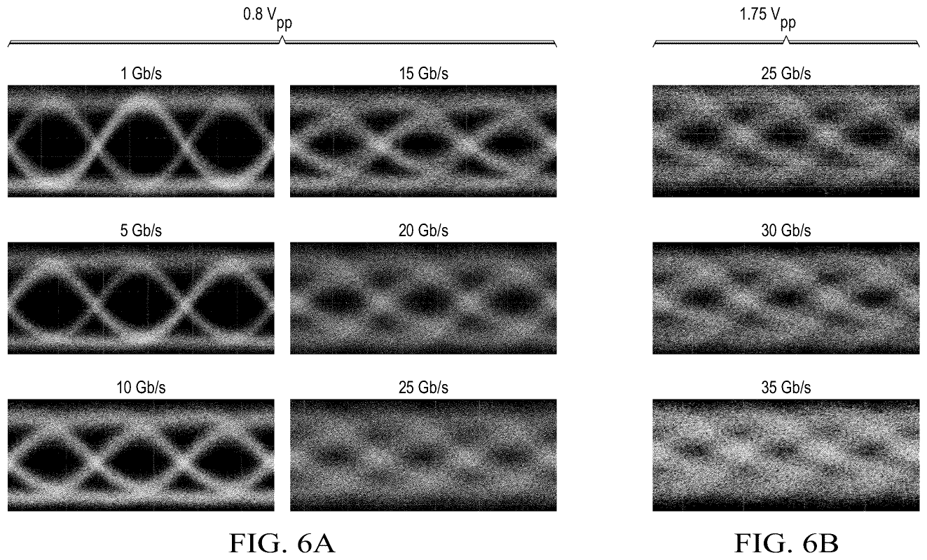

FIG. 6A are illustrative measured NRZ modulation eye diagrams of the illustrated HMTCO-gated MOSCAP Si-MRM with different data rates having a driving voltage of 0.8 Vₚₚ without any pre-emphasis signal. The optical eye diagrams at different data rates were obtained using a digital communication analyzer (DCA). It is evident from the diagrams that the eye remains open even at the data rate of 25 Gb/s. To push for even higher data rates, the S21 data from FIG. 5B was utilized as the input into the arbitrary waveform generator (AWG) to pre-emphasize the signals to enhance the quality of received signals at the DCA. Additionally, the ITiO-gated MOSCAP Si-MRM was driven with a higher voltage.

FIG. 6B are illustrative measured NRZ modulation eye diagrams of the HMTCO-gated MOSCAP Si-MRM with different data rates having a driving voltage of 1.75 Vₚₚ with the pre-emphasis signal. Pre-emphasis can lead to a cleaner and more open eye diagrams. However, it is important to note that pre-emphasis doesn't increase the actual bandwidth. Compared to FIG. 6A, it becomes apparent that the open eye at 25 Gb/s is even clearer, and the eyes are successfully opened to 35 Gb/s. At higher data rates, the primary limiting factor for the eye diagram is the actual bandwidth of the device. Additionally, in our testing configuration, the use of an optical amplifier introduced amplified spontaneous emission (ASE) noise, which had a detrimental effect on the clarity of the eye diagram. However, the ASE noise can be filtered out by a narrow band-pass optical filter.

The above illustrative embodiment can be optimized in several ways, some of which are discussed below. FIG. 5B demonstrated that the ITiO-gated MOSCAP Si-MRM achieved an E-O bandwidth of 11 GHZ, which is limited by the RC bandwidth since the photon lifetime-limited bandwidth supports up to 50 GHz with a Q-factor of 4600. The device's high overall capacitance of 500 fF hinders the bandwidth improvement. Although higher doping concentrations of the TCO and Si materials can lower the resistance, it will introduce greater optical absorption loss that can suppress the Q-factor with the price of higher driving voltages. Consequently, a more effective approach toward enhanced bandwidth lies in reducing the overall capacitance. However, a high capacitance density is important for improving the modulation efficiency. Therefore, optimal capacitance density with balanced performance is an important aspect of the MOSCAP microring modulator design.

Upon further analysis of the above embodiment, the HMTCO-gated MOSCAP 2 is formed by covering the top and two sidewalls of the microring waveguide 6 with ITiO, as well as the 500 nm width of the Si slab. The outer sidewall of the ring contributes over 50% of the total modulation, while the top of the waveguide and the slab act more like parasitic capacitance with minimal contribution to E-O modulation. This analysis suggests that the total capacitance can be significantly reduced by covering only the outer sidewall of the ring.

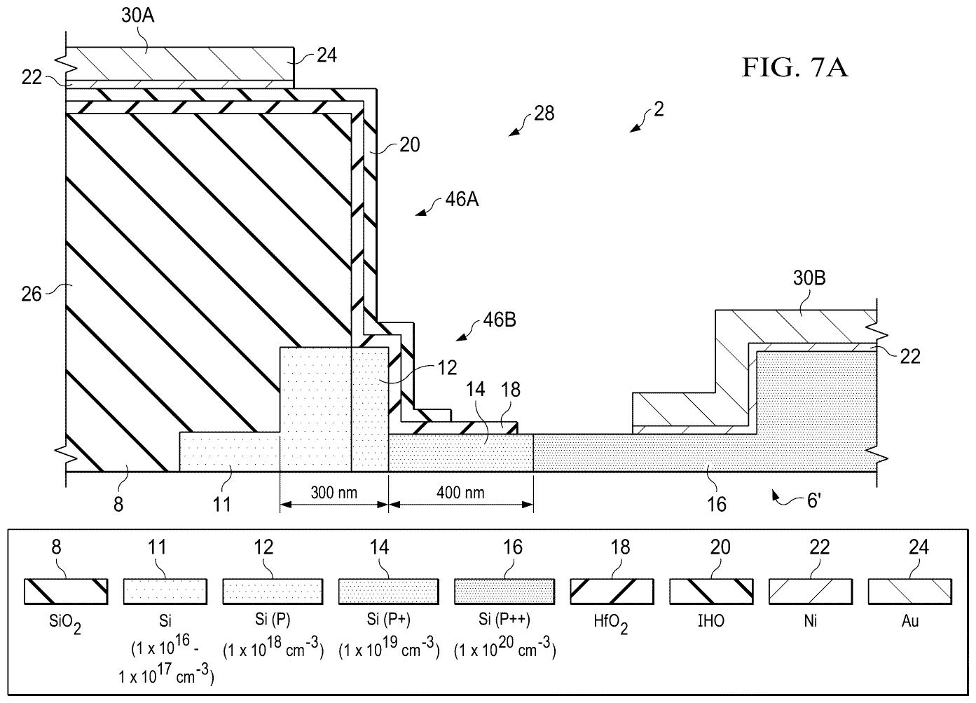

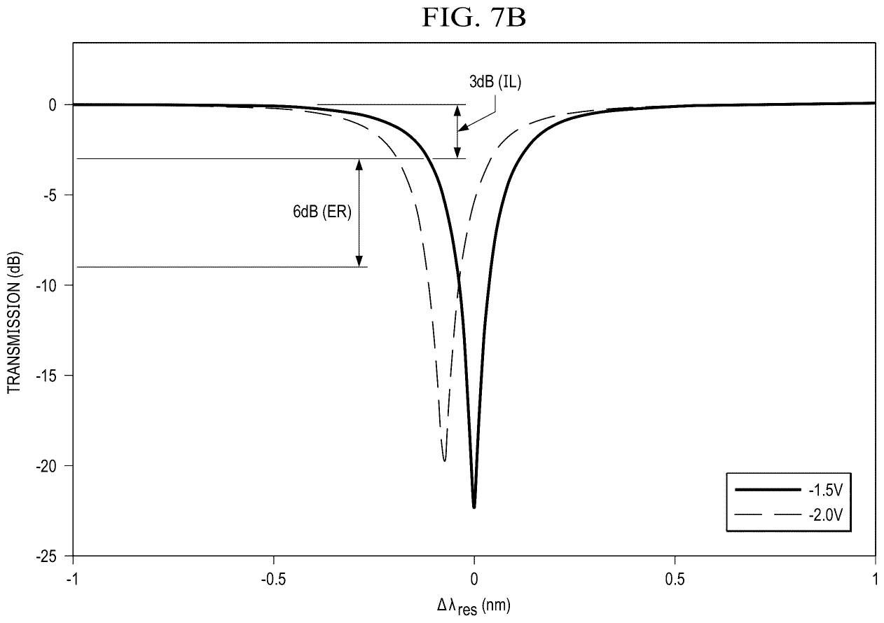

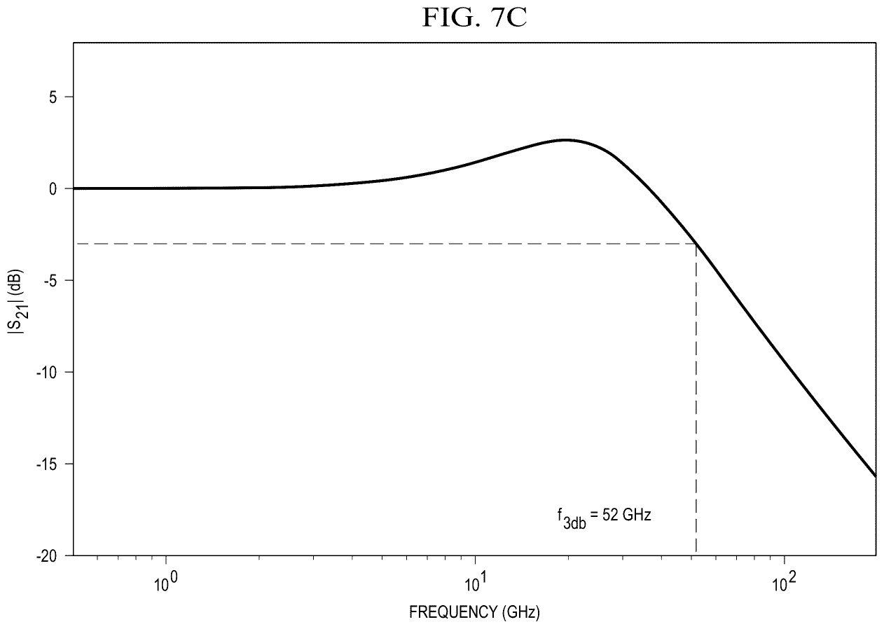

FIG. 7A is a schematic diagram of a cross-sectional view of an active region of another embodiment of an HMTCO-gated MOSCAP Si-MRM. Element numbers corresponding to prior figures with an additional cross-section of p-type silicon 11 with some background doping in the range of 10¹⁶˜10¹⁷ cm⁻³. In this embodiment, the relevant region of the MRM with HMTCO 20 covers only the outer sidewalls 46A and 46B of the microring waveguide 6′. In parallel, the thickness of the HfO₂ 18 is reduced from 10 nm to 6 nm, enhancing the capacitance density and improving E-O efficiency. Furthermore, employing a higher carrier mobility TCO, such as hydrogen-doped indium oxide (IHO), not only improves the Q-factor by reducing the optical loss but also decreases the series resistance. IHO has reported a high carrier mobility of 150 cm²/(V·s) with a concentration of 1.5×10²⁰ cm⁻³. Ni 22 and Au 24 can be deposited on the HMTCO for electrode 30A and on the Si(P++) portion 16 for the electrode 30B. Different doping levels of the Si are arranged to reduce overall resistance balanced with performance.

FIG. 7B is an illustrative graph of a static simulation of a blue-shifted spectra under −1.5 V and −2.0 V of the illustrative HMTCO-gated MOSCAP Si-MRM of FIG. 7A. Assuming the active E-O modulation region 28 shown in FIG. 1 occupies 70% of the microring, this structure allows the modulator to achieve a Q-factor of 6000 at 0 V. When the device is biased at −1.5 V, the Q-factor slightly reduces to 5600 with an E-O efficiency of 148 pm/V. Hence, the device can achieve a 6 dB ER with a 3 dB IL using only 0.5 Vₚₚ. Moreover, with this improved structure and the material properties, the total capacitance can be reduced from 500 fF to 218 fF, and the total series resistance will be 18 Ω, effectively supporting an RC bandwidth up to 40.6 GHz if we exclude the effect of source impedance. Due to the ultra-short electrode length of the microring modulator, the device can be simplified to a lumped component in a bandwidth simulation and characterization. The simulation accounts for both photon lifetime-limited bandwidth and RC bandwidth, resulting in a simulated E-O bandwidth that extends to 52 GHz.

25 FIG. 7C is a schematic graph of an illustrative transmission at λMOD (1317.54 nm) with respect to the gate voltage showing a simulated E-O response (S21) of the HMTCO-gated MOSCAP Si-MRM. The bandwidth is the illustrative 52 Gz. In addition, the energy efficiency can be improved to 13.6 fJ/bit. Another possibility to further improve the energy efficiency is to utilize subwavelength microring structures with minimized bending loss to achieve ultra-high overlapping factor between the optical mode and the accumulated carriers.

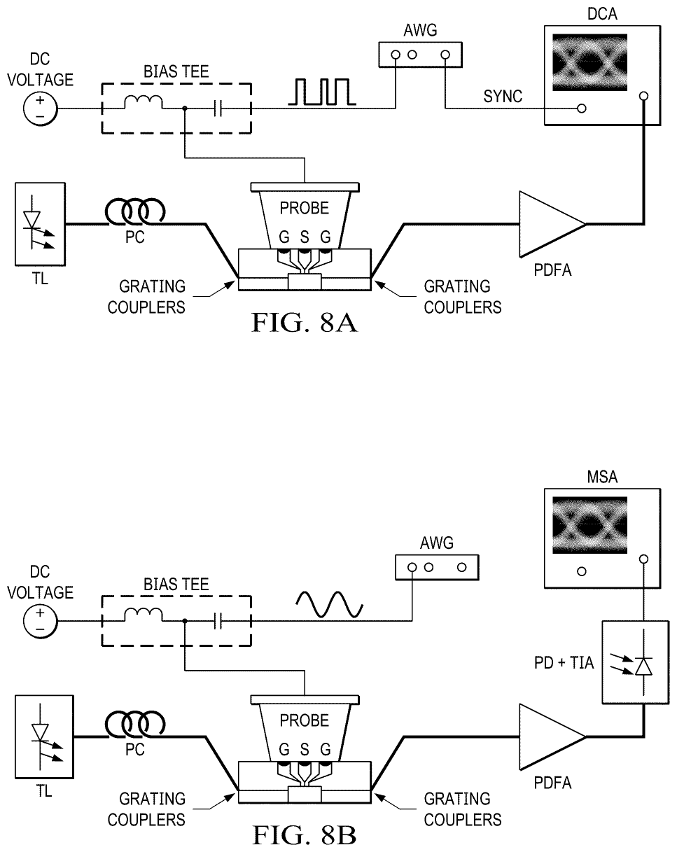

FIG. 8A is a schematic of an illustrative high-speed testing setup for eye diagrams testing. A PRBS electrical signal was generated using a 92 GSa/s AWG (Keysight M8196A), and it was combined with a DC bias through a 50-GHz bias tee (Keysight 11612B), ensuring optimal modulation of the electrical signal. Subsequently, this combined signal was applied to the device via an Infinity 40-GHz high-speed GSG probe. Simultaneously, a tunable laser (TL) (Santec TSL-570) was employed to generate the optical input, and the optical signals were coupled in and out through waveguide grating couplers. The modulated optical signal was then amplified by an O-Band Praseodymium-Doped Fiber Amplifier (PDFA) (Thorlabs PDFA100) before being detected by a 65 GHz optical module (Keysight N1030A) plugged to a DCA (Keysight N1000A). Finally, the DCA enables the acquisition of the optical eye diagram.

FIG. 8B is a schematic of an illustrative high-speed testing setup for E-O response testing. The E-O response shown in FIG. 5B was characterized using the experimental setup depicted in FIG. 8B. The single-frequency sine wave generated by the AWG was combined with a DC voltage using the bias tee before being utilized to drive the ITiO-gated MOSCAP Si-MRM. The device was modulated by the input single-frequency sine wave, resulting in an output-modulated optical signal detected by a 42 GHz photodetector with a built-in transimpedance amplifier (Thorlabs RXM42AF). Subsequently, the detected signal was further analyzed using a 26 GHZ MSA (HP8562A). To examine the frequency-dependent behavior of the E-O response, the input frequency of the sine wave was scanned, and the corresponding changes in the output power displayed on the MSA were observed. By systematically measuring the output power at different input frequencies, the S21 response of the ITiO-gated MOSCAP Si-MRM was characterized.

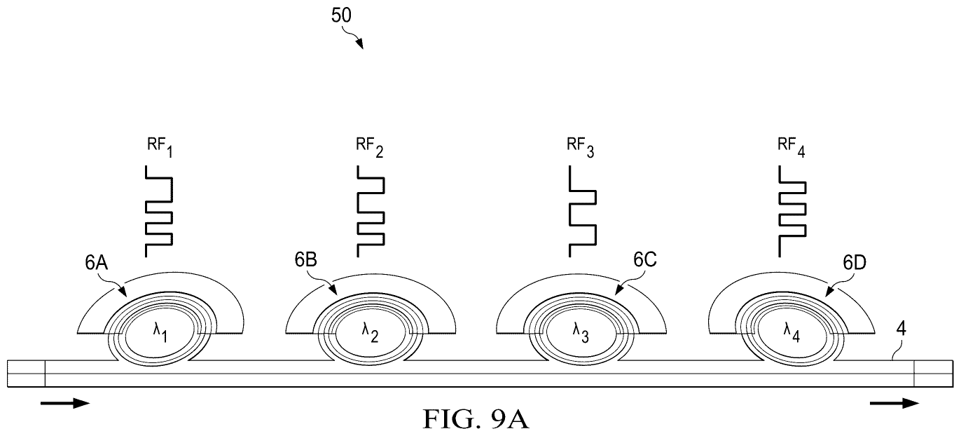

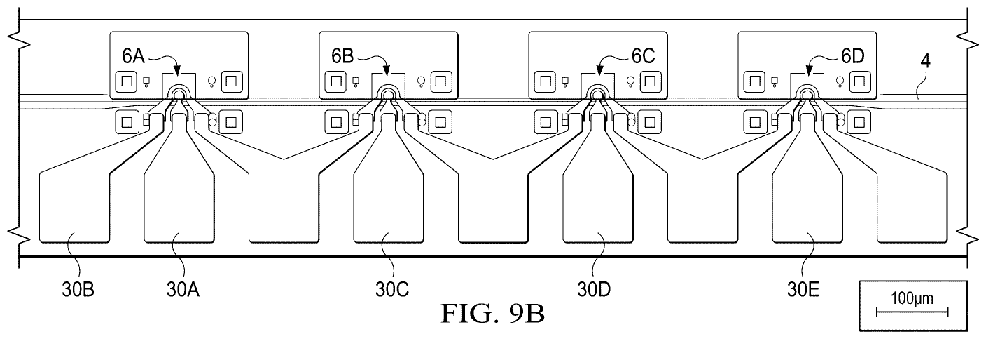

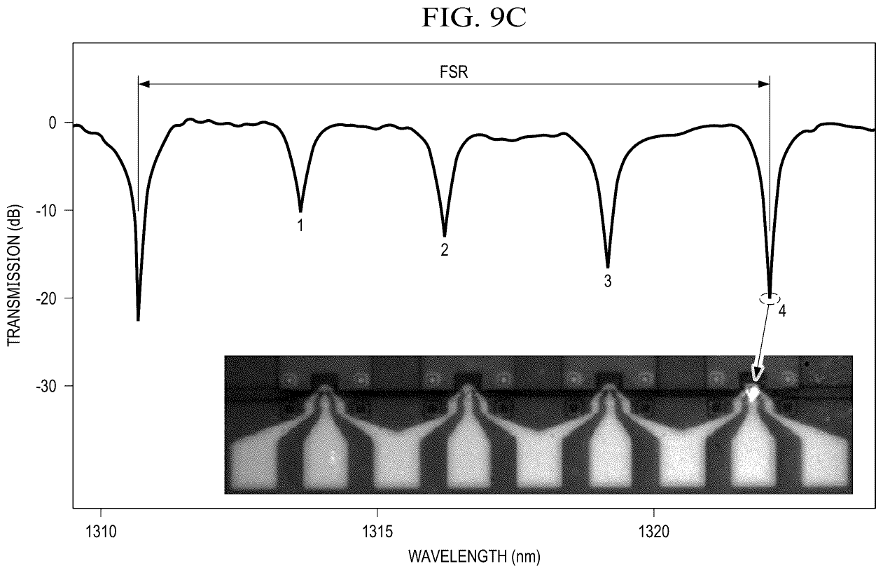

FIG. 9A is a schematic side view of an illustrative Si-MRM array of a plurality of microring waveguides on a common chip with a common bus waveguide. FIG. 9B is a schematic top view of the Si-MRM array of FIG. 9A. On-chip wavelength division multiplexing (WDM) allows simultaneous modulation and detection at multiple wavelengths through a single physical channel, which can significantly improve the bandwidth density of silicon photonics. A Si-MRM can provide WDM by coupling multiple Si-MRMs with slightly different radii to a single bus waveguide. Such a design enables electro-optic (E-O) modulation at various wavelengths concurrently, thereby maximizing the bandwidth density of photonic integrated circuits (PICs).

An exemplary HMTCO-gated Si-MRM array 50 is illustrated with four microring waveguides 6A, 6B, 6C, and 6D (generally, 6) that each having a resonant frequency, of which the radii vary for example, such as in this case, 6.00 μm, 6.02 μm, 6.04 μm, and 6.06 μm, respectively, to operate at four equally spaced wavelengths. The microring ring waveguides 6 act as the bottom substrates of the MOSCAPs, generally each featuring a 300 nm thick silicon rib waveguide with a 100 nm slab thickness. The waveguide width of the microrings is designed to be 300 nm to optimize E-O efficiency. The doping profile of silicon is designed to reduce the series resistance, thereby enhancing the modulation speed. The Si-MRM incorporates a background Si p-doping (1×1017 cm⁻³). The top of the microring waveguides, including part of the silicon slabs, features Si p+ doping (3×1018 cm⁻³). Additionally, the metal contact regions of electrodes are doped with Si p++ (1×1020 cm⁻³) and are approximately 600 nm away from their respective ring waveguides. Electrode 30A is delivers electric signals at different frequencies or real data signals to the TCO gate to drive the modulator, while electrode 30B is the ground electrode. Each waveguide has a separate electric signal electrode 30A, 30C, 30D, and 30E, but they share the same ground electrode 30B which are connected.

FIG. 9C is a schematic graph of a measured transmission spectrum with an insert photo showing light confinement within a HMTCO-gated Si-MRM at its resonant wavelength. The deep dip in the graph on the fourth HMTCO-gated Si-MRM indicates a resonant frequency occurrence in the transmission. The inset photo is from an infrared camera showing light confinement with the HMTCO-gated Si-MRM at its resonant wavelength.

In at least one embodiment, the 1×4 HMTCO-gated MOSCAP Si-MRM array using ITiO was co-fabricated utilizing an HVM silicon photonics fabrication with TCO patterning techniques similar to those described above. The HMTCO-gated Si-MRM array 50, with different radii was fabricated on a Silicon-on-Insulator (SOI) wafer using a 300 mm HVM silicon photonics process, involving Si (P), SI (P+), and Si (P++) doping, as described above. A SiO₂ 8 top cladding was deposited to safeguard the underlying silicon microring array. To integrate MOSCAP onto the doped silicon waveguide layer with TCO gates, the top SiO₂ cladding surrounding the active regions of the microrings underwent patterning via photolithography, followed by reactive ion etching (RIE) with Ar/CHF₃ gas mixture. This process exposed parts of the microrings while providing that both the bus waveguide and the coupling regions between the bus waveguide and microrings are covered by the SiO₂ cladding. A 10 nm HfO₂ insulator layer was uniformly deposited across the SOI substrate using atomic layer deposition (ALD), utilizing Tetrakis (ethylmethylamino) hafnium (TEMA-Hf) as the precursor and H₂O as the oxygen source at 300° C. Subsequently, a 14 nm ITiO layer was RF-sputtered onto the HfO₂ layer at a high substrate heating temperature of 500° C., covering the wafer. To form the ITiO layer only present at the active regions, a two-step patterning process was employed. Firstly, electron beam lithography (EBL) defined the desired ITiO pattern within the active regions, followed by RIE etching of ITiO with HBr gas. Secondly, photolithography was utilized to shield the active regions, facilitating selective removal of the residual ITiO layer using wet etching (ITO etchant). These sequential processes affirmed that the ITiO layer was selectively deposited only over the active regions of the microrings. Next, the HfO₂ layer in the silicon contact regions was patterned using EBL and removed by RIE with Ar/CHF₃ gas mixture. Finally, metal contacts were formed by thermal evaporation of Ni/Au metals, forming Ohmic contacts with both ITiO gates and the silicon bottom substrates.

FIG. 10A is a partial schematic flow chart of an exemplary process of fabrication of the HMTCO-gated MOSCAP Si-MRM. FIG. 10B is a further partial schematic flow chart of an exemplary process of fabrication of the HMTCO-gated MOSCAP Si-MRM. FIG. 10C is a further partial schematic flow chart of an exemplary process of fabrication of the HMTCO-gated MOSCAP Si-MRM. FIG. 10D is a further schematic flow chart of an exemplary process of fabrication of the HMTCO-gated MOSCAP Si-MRM. Element numbers correspond to prior figures. The passive Si microring HMTCO-gated MOSCAP Si-MRM 2 was fabricated on a silicon-on-insulator (SOI) wafer. An initial can be prefabricated by third parties or made inhouse according to known processes given the teachings herein and the exemplary layout described. An initial construction of the silicon slab 8 can include an exemplary doped Si (P) portion 12A to form a bus waveguide 4 and a microring 5 having a microring waveguide 6. The Si microring waveguide 6 has a narrow waveguide width such as about 300 nm and a waveguide height such as about 300 nm above other portions of the microring 5, while leaving a 100 nm thick Si slab 8 to ensure good optical mode confinement and proper electrical conduction. The bus waveguide 4 can be conductively coupled to a plurality of doped portions that can form a microring waveguide 6. The microring waveguide 6 can include a doped Si(P) portion 12B. The doped Si(P) 12B portion can be conductively coupled with a doped Si(P++) portion 16, which in turn can be conductively coupled with a doped Si(P+) portion 14A of the microring waveguide. The doped Si(P+) portion 14A can be conductively coupled with a doped Si(P) portion 12C, which can be conductively coupled at an upper surface with a doped Si(P+) portion 14B and conductively coupled at a side with a doped Si(P+) portion 14C within the Si slab 8.

Cladding of the Si slab 8 can be etched for example by a reactive-ion etching (RIE) process to reveal doped portions of the microring 5, generally excepting the doped Si(P) portion 12A and portions of the structure distal from the bus waveguide 4 relative to the microring 5. Thus, the cladding etching step reveals the Si(P++) portion 16, Si(P+) portion 14A, Si(P) portion 12C, Si(P+) portion 14B, Si(P+) portion 14C, and a portion of the Si slab 8 at a level aligned with the Si(P+) portion 14C.

A dielectric layer 18 of HfO₂ can be deposited over the etched portion of the Si slab 8 to cover the revealed portions after the etching. For example, an atomic layer deposition (ALD) process can be used to deposit very thin films.

Next, the HMTCO layer 20, such as a ITiO layer, can be deposited over the Si slab 8 and dielectric layer 18. For example, a sputtering process can be used in which source material is bombarded with energetic ions, which results in the ejection of atoms and their subsequent deposition onto the substrate.

Portions of the layers can be selectively removed using various methods to form the needed structure. The HMTCO layer 20 can be etched to remove a portion deposited over the dielectric layer 18 in the areas of the structure doped Si(P++) portion 16 and some of the doped (P+) portion 14A. The HMTCO layer 20 generally is retained over the dielectric layer 18 in an active region of the microring 6, including a portion of the doped Si(P+) portion 14A, doped Si(P+) portion 14B, doped Si(P+) portion 14C, and a portion of the Si-slab 8 aligned with the doped Si(P+) portion 14C.

Further, a portion of the dielectric layer can be removed by etching that is previously exposed by the removal of the portion of the HMTCO layer. For example, the RIE process can be used.

Electrodes can be deposited over the structure. An electrode 30A can be deposited over the Si slab 8 around the bus waveguide 4, along a sidewall formed by the cladding removal, and over a portion of the doped Si(P++) portion 16. An electrode 30B can be deposited over a portion of the HMTCO that is deposited on the Si slab without the dielectric layer that is distal from the electrode 30A relative to the active region of the microring having both the HMTCO and dielectric layer in the area of the doped Si(P+) portions 14A, 14B, and 14C, which form an active region 38.

As a nonlimiting example using HfO₂ as a high dielectric constant insulator and titanium-doped indium oxide (ITiO) as the high carrier mobility transparent conducting oxide, the exemplary method of fabrication can include acquiring or fabricating a silicon-on-insulator (SOI) wafer having a Si microring waveguide 6 with a waveguide width of 300 nm and a waveguide height of 300 nm while leaving a 100 nm thick Si slab 8 to ensure good optical mode confinement in the Si waveguide 4 and proper electrical conduction. To create the MOSCAP on the microring, the top SiO2 cladding in the active region 28 of the microring 5 can be selectively patterned using regular photolithography, followed by reactive-ion etching (RIE). Next, a 10 nm HfO₂ insulator layer 18 can be deposited on the SOI substrate by atomic layer deposition (ALD) using tertrakis (eythylmetylamido)-Hf (TEMA) and H₂O at 300° C. Subsequently, a 14 nm ITiO layer 20 can be RF-sputtered onto the HfO₂ layer at a high substrate heating temperature of 500° C., which covers the wafer with ITiO. The ITiO layer in the active region 28 can be patterned using a two-step process. Electron beam lithography (EBL) with RIE can be used to accurately define the desired ITiO pattern within the active region. Subsequently, regular photolithography with wet etching (ITO etchant) can be used to remove any residual ITiO. After these two steps, the ITiO layer can cover approximately 62.5% of the microring circumference. Prior to the metal deposition, the HfO2₂ layer in the Si contact region can be patterned using EBL and removed by RIE. The Ni/Au electrical contacts 30 can be patterned on the ITiO gate and the Si substrate using EBL, followed by thermal evaporation and lift-off. These contacts can be patterned approximately 1.2 μm away from the microring waveguide. Finally, the Ni/Au coplanar ground-signal-ground (GSG) electrode pads can be patterned using regular photolithography, followed by thermal evaporation and lift-off, which are connected to the electrical contacts patterned in the previous step.

In summary, the disclosure supports that inventor successfully demonstrated the integration between silicon photonics and high-mobility TCO material to create a highly efficient HMTCO-gated MOSCAP Si-MRM. It exhibited an exceptional E-O efficiency of 117 pm/V, along with a Vπ·L of 0.12 V·cm. With an E-O bandwidth of 11 GHZ, it achieved a 25 Gb/s open eye at a sub-volt Vpp of 0.8 V with an energy efficiency of 53 fJ/bit. With further optimization of the device structure, it has the potential to achieve a 0.5 Vpp while increasing the E-O bandwidth to 52 GHZ, enabling data encoding at 100 Gb/s for the next generation of high-speed optical communication with an energy efficiency of 13.6 fJ/bit. In conclusion, the highly efficient ITiO-gated MOSCAP Si-MRM disclosed herein has a significant impact on energy-efficient optical communication and computation. Its sub-volt driving voltage offers the feasibility of direct CMOS driving without any voltage amplifier, which can potentially reduce the transmitter side power consumption by an order of magnitude. It will also bridge the gap of the driving voltage between neuromorphic computing and photonic modulators, enabling low-energy photonic computing for artificial intelligence.

Unless otherwise defined, all technical and scientific terms used herein have the same meaning as commonly understood by one of ordinary skill in the art to which this invention belongs. Suitable methods and materials are described herein, although methods and materials similar or equivalent to those described herein can be used in the practice or testing of the invention. All publications, patents, and other references mentioned herein are incorporated by reference in their entirety. In case of conflict, the present specification, including definitions herein, will control. In addition, the materials, methods, and examples are illustrative and not intended to be limiting.

Other and further embodiments utilizing one or more aspects of the invention described above can be devised without departing from the spirit of the Applicants' invention. For example, spacings between layers vertically and transversely can vary, thickness of layers can vary, compositions including doping can vary, otther compositions can vary, such further dielectric materials including Al₂O₃, ZrO₂, and HAOL (laminated HfO₂/Al₂O₃), further TCO compositions including ITiO, IHO, Ti:In2O3 (ITiO), tungsten-doped indium oxide (IWO), and molybdenum-doped indium oxide (IMO), further compositions for the metal electrodes including nickel-aluminum, aluminum, or nickel-tungsten compositions, and other parameters can vary.

The invention has been described in the context of preferred and other embodiments and not every embodiment of the invention has been described. Obvious modifications of the methods and systems include variations that a person with ordinary skill in the art would envision, given the teachings herein. The disclosed and undisclosed embodiments are not intended to limit or restrict the scope or applicability of the invention conceived of by the Applicant, but rather, in conformity with the patent laws. Applicants intend to protect fully all such modifications and improvements that come within the scope of the following claims.

What is claimed is:

1. A silicon microring modulator (Si-MRM) comprising:
a silicon substrate;
a bus waveguide formed on the silicon substrate;
a subwavelength-sized silicon microring waveguide coupled to the substrate;
a high dielectric constant insulator having a value of least κ=10 deposited on the silicon waveguide;
a high carrier mobility transparent conducting oxide (HMTCO) having a carrier mobility value of at least 60 cm₂/(V·s) deposited on the insulator to form metal-oxide-semiconductor capacitor; and
a plurality of electrodes and wherein the microring waveguide is formed with a radius and the insulator and HMTCO are formed on the microring waveguide to establish an active region gated by the HMTCO between a first electrode and a second electrode.

2. The silicon microring modulator of claim 1, wherein the microring waveguide comprises a plurality of silicon regions having different doping levels between the first electrode and the second electrode to reduce series resistance between the electrodes.

3. The silicon microring modulator of claim 1, wherein the Si-MRM modulates with a sub-volt gate voltage.

4. The silicon microring modulator of claim 1, wherein the microring waveguide forms a rib with a top and at least one sidewall that extends above a Si slab, and wherein the HMTCO is deposited on at least one sidewall.

5. The silicon microring modulator of claim 1, further comprising a plurality of Si-MRMs coupled to a common bus waveguide to form an array, the Si-MRMs having different radii and thus different resonant frequencies and configured for on-chip wavelength division multiplexing.

6. A method of fabricating a silicon microring modulator on a silicon-on-insulator (SOI) wafer having doped portion configured to form a bus waveguide and a doped portion configured to form a microring with a microring waveguide on a silicon slab, comprising:
etching the silicon slab to expose a plurality of doped silicon portions of having different doping levels with a microring waveguide having a height to form at least one sidewall and a top;
depositing a layer of dielectric over the plurality of doped silicon portions;
depositing a layer of transparent conducting oxide over the silicon slab and the dielectric layer;
etching the transparent conducting oxide from a portion of the dielectric layer, leaving the transparent conducting oxide over the dielectric layer on the microring waveguide;
etching the dielectric layer over a portion of the plurality of doped silicon portions, leaving the dielectric layer on the microring waveguide and on a portion of the Si slab with the transparent conducting oxide that is distant from the bus waveguide relative to the microring waveguide; and
deposition a first electrode on a portion of the silicon slab and portion of the microring and depositing a second electrode on a second portion of the silicon slab distant from the first electrodes relative to the microring waveguide, the first electrode being coupled through the microring to the second conductor.

7. The method of claim 6, wherein depositing the layer of dielectric comprises depositing dielectric with a dielectric constant having a value of least κ=10.

8. The method of claim 6, wherein deposing the layer of transparent conducting oxide comprises depositing transparent conducting oxide having a carrier mobility value of at least 60 cm₂/(V·s).

9. The method of claim 6, wherein the etching comprises at least one of etching by reactive-ion etching, electron beam lithography, and photolithography.

10. The method of claim 6, wherein depositing comprises depositing by at least one of atomic layer deposition, radio frequency sputtering, and metal evaporation.
